(19) United States
(12) Patent Application Publication
(10) Pub. No.: US 2003/0034438 A1
(43) Pub. Date: Feb. 20, 2003

(54) Optoelectronic device-optical fiber connector having micromachined pit for passive alignment of the optoelectronic device

(76) Inventors: David W. Sherrer, Radford, VA (US); Noel A. Heiks, Radford, VA (US); Dan A. Steinberg, Radford, VA (US)

Correspondence Address: Joseph P. Quinn, Esq., Brown Rudnick Berlack Israels LLP, One Financial Center, Boston, MA, 02111, US

(21) Appl. No.: 10/192,752

(22) Filed: Jul. 10, 2002

Related U.S. Application Data
(63) Continuation of application No. 09/574,482, filed on May 19, 2000, now abandoned.
Application No. 09/574,482 is a continuation-in-part of application No. 09/199,545, filed on Nov. 25, 1998, now abandoned.

(51) Int. Cl. H01J 3/14; H01J 5/16

(52) U.S. Cl. 250/216

(57) ABSTRACT

A connector for optically connecting an array of optoelectronic device (e.g. VCSELS or photodetectors) and an array of optical waveguides (e.g. optical fibers or integrated optical waveguides). The device has a submount chip for holding the optoelectronic device. The submount chip has a micromachined pit and the OE device is disposed in the pit. The pit has sidewalls that provide mechanical alignment for the OE device. The submount also has holes for receiving guide pins. The connector also has a waveguide array such as a V-groove optical fiber array. The waveguide array has edges of holes for contact with the guide pins. When the guide pins are inserted into the submount chip, the waveguides are automatically aligned with the optical waveguides. The present invention is also directed to the submount chip and OE device combination.

### RELATED APPLICATIONS

The present application is a continuation-in-part of copending patent application Ser. No. 09/199,545 filed Nov. 25, 1998, which is hereby incorporated by reference.

### FIELD OF THE INVENTION

The present invention relates generally to fiber optic and photonic devices. More particularly, it relates to a connector for coupling an optical fiber array to an array of optoelectronic devices.

### BACKGROUND OF THE INVENTION

In the fiber optics industry there is a great demand for connector devices and packages for coupling optical fibers and optoelectronic (OE) devices (e.g. light sources, VCSELs, photodetectors. Such connectors are useful for optical transmit/receive devices.

Many prior art OE-fiber connectors and packages have a large number of parts, rendering them expensive and difficult to manufacture. In the future, fiber optics components will be demanded in high volume. Easily manufacturable devices will be required.

U.S. Pat. No. 5,091,991 to Briggs et al. discloses a connector for coupling an optical fiber to an optoelectronic device. The device has pins for aligning the optical fibers and the optoelectronic devices.

U.S. Pat. No. 5,212,754 to Basavanhally et al. discloses an optical fiber/laser connector. The connector has guide pins and the laser is disposed between two micromachined chips. The chips have features on their edges for receiving the guide pins.

U.S. Pat. No. 5,199,093 to Longhurst discloses an optical connector having guide pins. The device is for connecting optical fibers.

U.S. Pat. No. 5,216,732 to Knott discloses an optical fiber connector having a number of optical fiber connectors disposed in a simple mechanical connector. The mechanical connector provides rough alignment for the fiber connectors, and the fiber connectors provide precise alignment for the optical fibers.

U.S. Pat. No. 5,281,301 to Basavanhally discloses an assembly for aligning optical fibers with an optoelectronic device and microlenses. The device uses microlenses for mechanical alignment as well as focusing.

U.S. Pat. No. 5,248,704 to Lebby et al. discloses a device for coupling optical fibers and optoelectronic devices. The device has an optoelectronic device encased within clear moldable material. The moldable material has features for accepting alignment pins attached to an optical fiber array.

U.S. Pat. Nos. 5,420,954 and 5,631,988 to Swirhun et al disclose a connector for connecting OE devices and optical fibers. The device has a chip with integral OE devices and etched or machined holes. The holes in the chip accept guide pins for alignment of optical fibers.

U.S. Pat. No. 5,917,976 to Yamaguchi discloses a connector for optical fibers and OE devices. The connector of Yamaguchi has a silicon substrate with etched alignment holes for receiving guide pins. The silicon substrate has pads for flip chip bonding aligned with the alignment holes. The OE device is secured to the flip chip pads and is thereby aligned with the optical fibers.

### OBJECTS AND ADVANTAGES OF THE INVENTION

Accordingly, it is a primary object of the present invention to provide an optoelectronic device/optical fiber connector that:

1) is simple to manufacture precisely;

2) has relatively few parts

3) provides accurate alignment for optical fibers;

4) can be made using well known micromachining techniques.

These and other objects and advantages will be apparent upon reading the following description and accompanying drawings.

### SUMMARY OF THE INVENTION

These objects and advantages are attained by the present apparatus for connecting an optoelectronic device and a waveguide array. The present apparatus has a submount chip with a micromachined pit, an optoelectronic device disposed in the micromachined pit, a waveguide array, and at least two guide pins for connecting the submount chip and the waveguide array. The submount chip has pin-guiding features. The pin-guiding features can comprise guide pin holes or notched edges. The waveguide array has pin-guiding features for holding the guide pins essentially parallel with the waveguides.

Preferably, the micromachined pit is deeper than the thickness of the OE device, so that the OE device is countersunk in the submount chip.

The micromachined pit can extend to the edge of the submount chip.

The submount chip can be made from single crystal silicon, such as <100> silicon. In this case, the micromachined pit can be made by wet etching.

Also, the submount chip can be made from a silicon-on-insulator (SOI) chip. In this case, the bottom of the micromachined chip can be defined by the insulator layer.

Also, electrical transmission lines can be provided in the micromachined pit. The transmission lines can extend through vias in the submount.

The micromachined pit can have many different sidewalls and sidewall combinations. The sidewall can be vertical, sloped, or a combinations. The sidewall can also have a two-level structure. A two-level structure is beneficial for supporting a wire bond to the OE device. Also, the sidewall can be undercut.

Also, the OE device and the submount chip can have coplanar surfaces. In one embodiment, the OE device and submount chip are lapped in a simultaneous lapping step.

The present invention is also directed toward a submount having an OE device disposed in the micromachined pit. The submount has pin-guiding features such as guide pin holes or notched edges. Preferably, the OE device is disposed against the sidewall of the micromachined pit.

The present invention is also directed toward an embodiment where the guide pins and pin-guiding features are replaced with guide spheres (e.g. ball lenses) and sphere guiding features. The submount has sphere-guiding pits (e.g. etched pits) and the waveguide array has sphere-guiding features such as pits or v-grooves.

### DESCRIPTION OF THE FIGURES

FIG. 1 shows a side view of the present optical connector. The connector is not fully engaged in this view.

FIG. 2 shows a front view of the waveguide array (V-groove fiber array) used with in the present invention.

FIG. 3 shows a side view of the present connector fully connected. An optional heat sink is also shown.

FIG. 4 shows a perspective view of a submount according to the present invention.

FIG. 5 shows a top view of the submount of FIG. 4, without the optoelectronic (OE) device.

FIGS. 6a-6b show an alternative embodiment having two micromachined pits.

FIGS. 7a-7b show an alternative embodiment having two micromachined pits.

FIG. 7c shows a top view of a submount having notched edges for guiding pin features.

FIG. 8 shows an embodiment where the micromachined pit extends to an edge of the submount chip.

FIG. 9 shows a side view of the submount of FIG. 8.

FIG. 10 shows a side view illustrating the transmission lines.

FIGS. 11-13 show embodiments where the electrical connections extend along the submount edge.

FIG. 14 shows an embodiment where the OE device communicates with the waveguides through the submount chip.

FIG. 15 shows a top view of the submount chip of FIG. 14, illustrating optional holes.

FIG. 16 shows vias for electrical connection to the OE device.

FIG. 17 shows a perspective view of the submount where the micromachined pit has vertical sidewalls and the submount chip is made from an SOI chip.

FIGS. 18-20b show various embodiments possible with SOI substrate chips.

FIGS. 21-23b show various embodiments with different sidewalls.

FIG. 24 shows an embodiment where the OE device is taller than the submount chip, and spacer layers are used.

FIG. 25 an integrated optic connector than can be connected to the submount of the present invention.

FIGS. 26a-e illustrates a method for making the two-level sidewall.

FIGS. 27a-e illustrates a method for making a submount having both vertical and sloping sidewalls.

FIG. 28 illustrates an alternative embodiment where guide spheres are used instead of guide pins.

FIG. 29 shows a perspective view of a waveguide array for use with guide spheres.

### DETAILED DESCRIPTION

The present invention provides a connector/package for coupling optoelectronic (OE) devices (e.g. VCSELs, LEDs, photodetectors) to optical fibers or optical waveguides. The apparatus of the invention has a micromachined submount chip with a pit and an optical fiber array. The submount and array also have features for guide pins or guide spheres. The guide pins or guide spheres provide mechanical alignment between the submount and array. The submount may have guide pin holes for the guide pins. The guide pin holes are located to receive the guide pins so that the micromachined submount chip is accurately aligned with the fiber array. The pit is accurately located with respect to the guide pin holes and contains the OE device. Sidewalls of the pit provide accurate passive OE alignment for the OE device. The pit can be made using wet anisotropic etching or dry etching. The micromachined submount chip can comprise a solid silicon chip, an SOI chip (e.g. silicon-SiO2-silicon), or other materials (e.g. plastic, silica, ceramic).

FIG. 1 shows a side view of the present invention. The present invention comprises a V-groove fiber array 20 having guide pins 22 and optical fibers 24. The optical fibers and guide pins are disposed in V-grooves (not visible). The guide pins 22 and optical fibers 24 are accurately located with respect to one another, as is known in the art of optical fiber connectors. The fiber array is shown having 2 guide pins and 6 optical fibers, but the fiber array can have any number of optical fibers and any number of guide pins greater than 1.

The optical connector of the present invention also comprises a micromachined submount chip 26. For clarity, the submount 26 is shown only partially engaged with the V-groove fiber array 20. The submount 26 has two micromachined holes 28 for receiving the guide pins 22. The submount has a micromachined pit 30; the pit has a sidewall 32. Preferably, a bottom 34 of the pit is flat, as shown. An optoelectronic (OE) device 36 (e.g., a VCSEL array, photodetector array, or filter array) is disposed in the micromachined pit 30. The OE device 36 is butted against the sidewall 32 so that it is passively aligned with respect to the micromachined pit 30 and micromachined holes 28. Optionally, the guide holes 28 are larger than the guide pins 22, providing a gap 25 between the guide pins and hole edge This helps prevent damage to the submount when the pins are inserted. The guide pins can be made of metal.

In the embodiment of FIG. 1, the submount chip is made of silicon, and the pit is formed by wet anisotropic etching is (e.g. using KOH) of silicon. However, the submount chip can be made of many micromachinable materials other than silicon including silica and plastics Also, the micromachined pit 30 can be made by reactive ion etching.

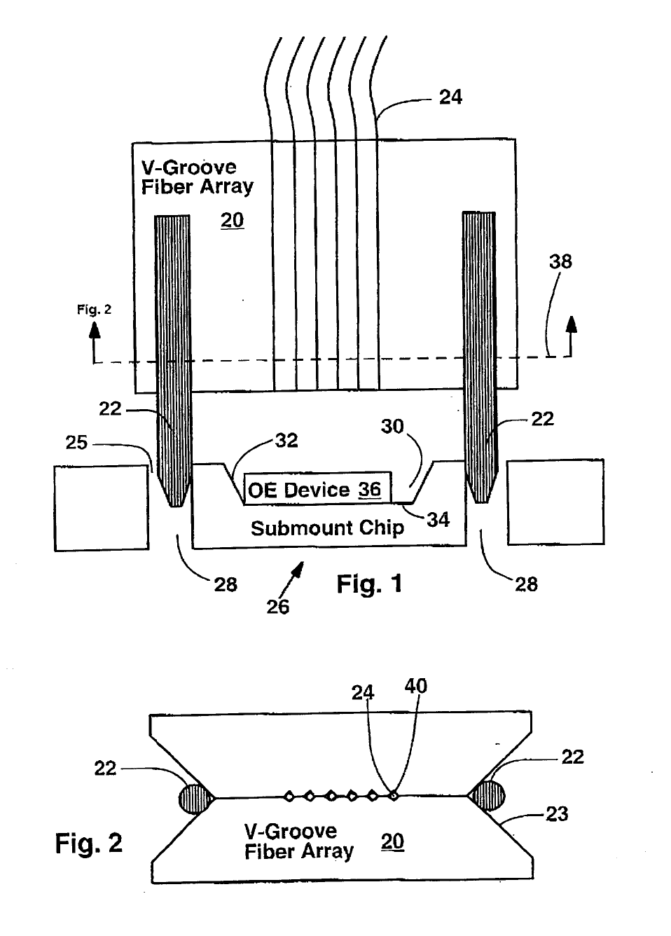

FIG. 2 shows a cross sectional view of the V-groove fiber array 20 cut along line 38 (shown in FIG. 1) . The V-groove array comprises two silicon chips having anisotropically etched V-grooves 40. Optical fibers 24 are disposed in the V-grooves. The array has beveled edges 23 which function as guiding features for the guide pins 22.

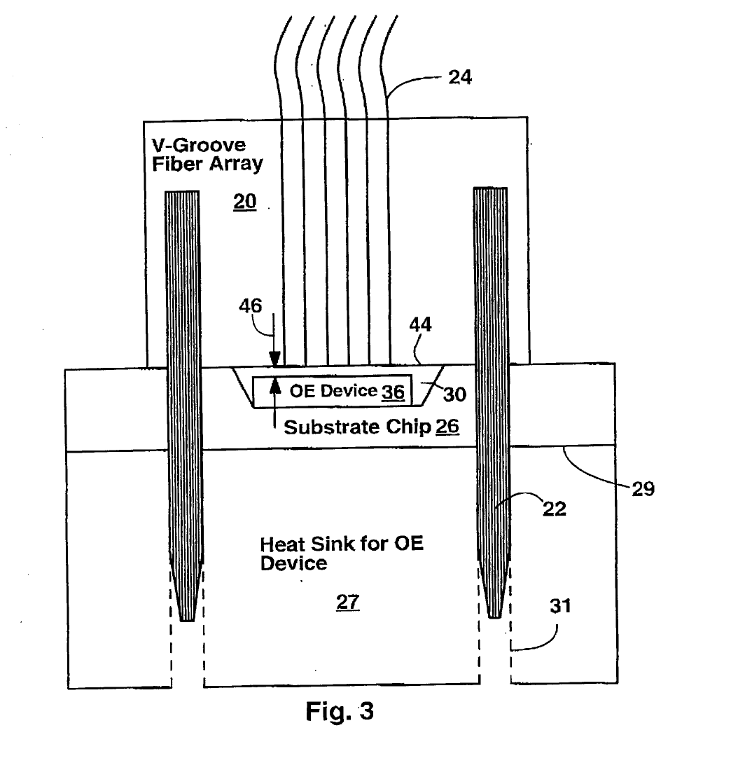

FIG. 3 shows the present connector fully engaged. The submount chip 26 is pressed against a front face 44 of the fiber array 20. The front face 44 and OE device are separated by a gap distance 46. The gap 46 is determined by a thickness of the OE device and the depth of the micromachined pit 30. The gap 46 is the distance between the optical fibers and the OE device. The micromachined pit is preferably deeper than the thickness of the OE device, so that gap 46 exists below the top surface of the submount as shown. The micromachined pit may be 250, 400, 500 or 600 microns deep, for example. The optimal gap distance depends on the optical fibers or waveguides used and the optical characteristics of the OE device. For many applications, the gap 46 should be less than 100, 50, 20, 10, 5 or 1 microns.

FIG. 3 also shows an optional heat sink 27 in contact with a backside 29 of the submount chip 26. The heat sink 27 has guide pin holes 31 for receiving the guide pins 22 and aligning the heat sink with respect to the submount.

The guide pin holes 28 in the submount chip are preferably made using RIE or DRIE processes. The guide pin holes are lithographically defined and therefore precisely located with respect to the micromachined pit 30 and sidewalls 32. Precise location of the pit 30 and guide pin holes 28 is essential for providing accurate passive alignment between the optical fibers 24 and OE device 36. Preferably, the guide pin holes 28 and micromachined pit 30 are defined using a single masking step. In a particularly preferred embodiment, the guide pin holes 28 and the micromachined pit 30 are made using a single step lithographic process described in patent application Ser. No. 09/519,165 entitled “Single Mask Lithographic Process for Patterning multiple Types of Surface Features” filed on Mar. 6, 2000 and herein incorporated by reference.

The OE device 36 can be attached to the submount chip 26 using flip-chip technology or solder reflow. Optionally, if solder reflow is used, the solder pads are placed close to the sidewall 32 so that surface tension forces during reflow urge the OE device to press against the sidewall 32. This helps to assure that the OE device is properly located with respect to the pit 30 and guide pins 28. Also, metallization patterns in the micromachined pit 30 provide electrical connections to the OE device 36. The metallization patterns can include transmission lines for high-speed operation of the OE device.

Of course, the OE device must be accurately diced so that the active electronics (e.g., VCSELS, photodetectors) are accurately located with respect to the chip edges of the OE device. For example, the OE device may be separated from a wafer using DRIE or anisotropic wet etching, as known in the art. Dice cut from a wafer using DRIE or anisotropic wet etching can be defined using lithographic techniques. U.S. Pat. No. 4,961,821 describes several useful techniques for accurate dicing of semiconductor chips.

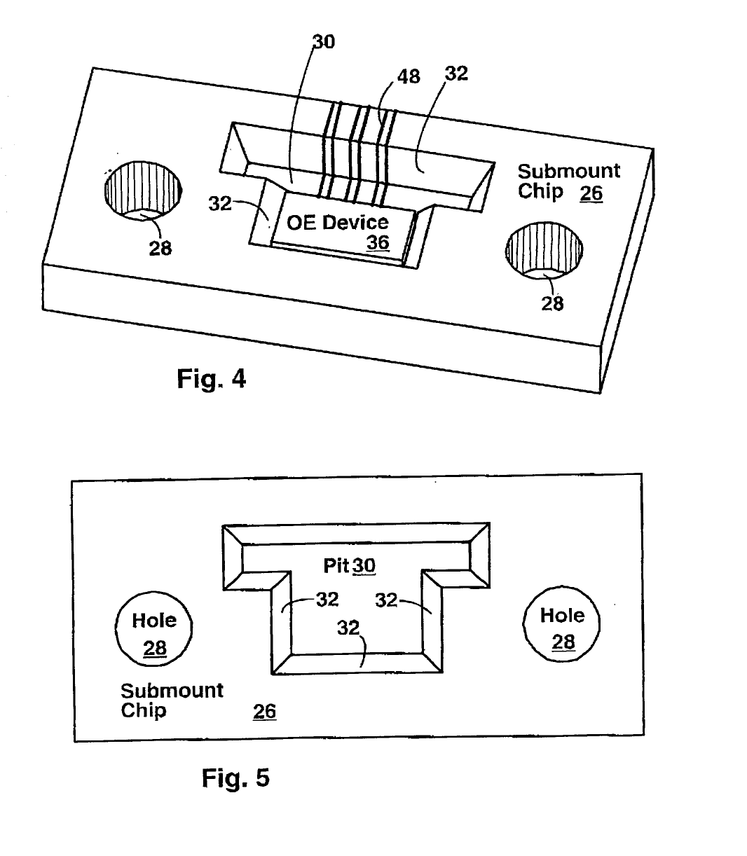

FIG. 4 shows a perspective view of a specific embodiment of the submount chip 26 where the micromachined pit 30 has a T-shape. The OE device 36 is disposed in the base of the T-shape. Sidewalls 32 passively locate the OE device 36 so that its position and orientation are fixed. Transmission lines 48 provide electrical connections for the OE device 36. The T-shape provides space for the transmission lines. The transmission lines 48 extend over the sidewall 32. The sidewall with transmission lines must be a sloping sidewall; generally, the sloping sidewall should have an angle of at least 30 degrees with respect to vertical in order to support the transmission lines.

In the specific embodiment shown in FIG. 4, the submount chip 26 is made of <100> silicon and the micromachined pit 30 is made by wet anisotropic etching (e.g., using KOH).

FIG. 5 shows a top view of the submount chip shown in FIG. 4.

The submount chip 26 of the present invention can have micromachined pits 30 with many different shapes and profiles. The sidewalls 32 of the pit 30 can be sloped, rounded or vertical, for example. Also, the pit can be rectangular or can have any polygonal shape accommodating to the OE device chip 36. Also, the submount chip 26 can have more than one micromachined pit, if desired.

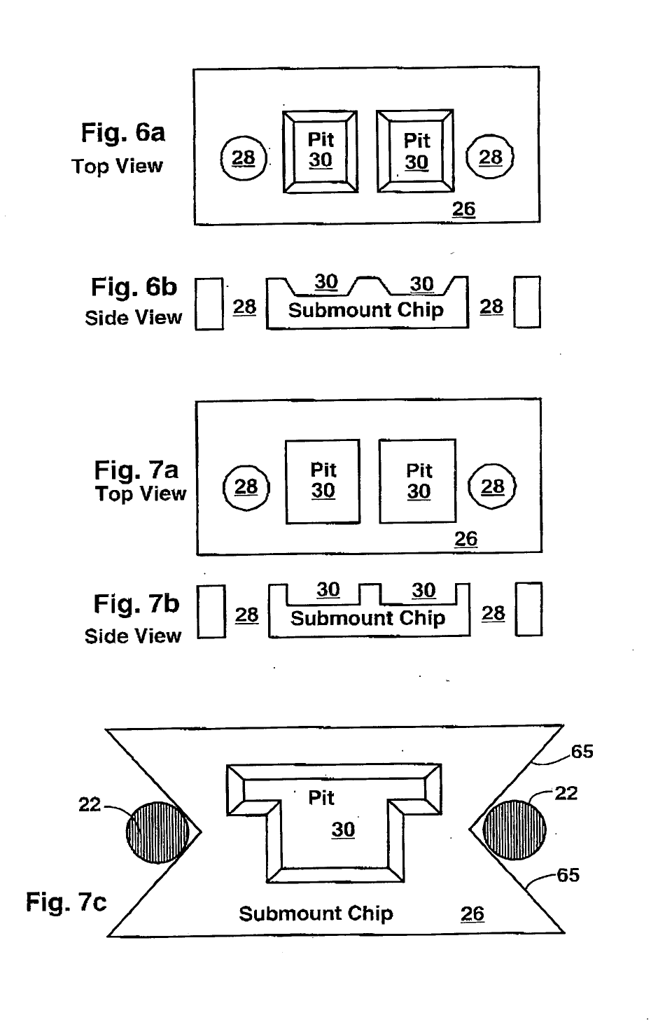

FIGS. 6a (top view) and 6b (side view) show an alternative embodiment where the submount chip 26 has two micromachined pits 30. Each pit holds an OE device chip (not shown).

FIGS. 7a (top view) and 7b (side view) show an alternative embodiment where the pit has vertical sidewalls. In this embodiment, the pit can be made using DRIE or other directional etching processes (e.g. vertical etching of <110> silicon, although this produces two vertical and two sloping sidewalls).

It is also noted that the guide pin holes 28 and the guide pins 22 can have many different shapes. Of course, the guide pins and guide holes must have sizes and shapes selected so that they interlock with tight clearances. This is necessary for accurate alignment between the submount and array. The guide pin holes can be square, oval or diamond shaped, for example. Similarly, the guide pins can be square, oval or diamond shaped. Also, the guide pin holes can be chamfered (i.e., have a funnel shaped opening) to facilitate insertion of the guide pins into the guide pin holes.

FIG. 7c shows an alternative embodiment where the submount does not have guide pin holes. The submount has accurately located ‘notched’ edges 65 that function as pin guiding features.

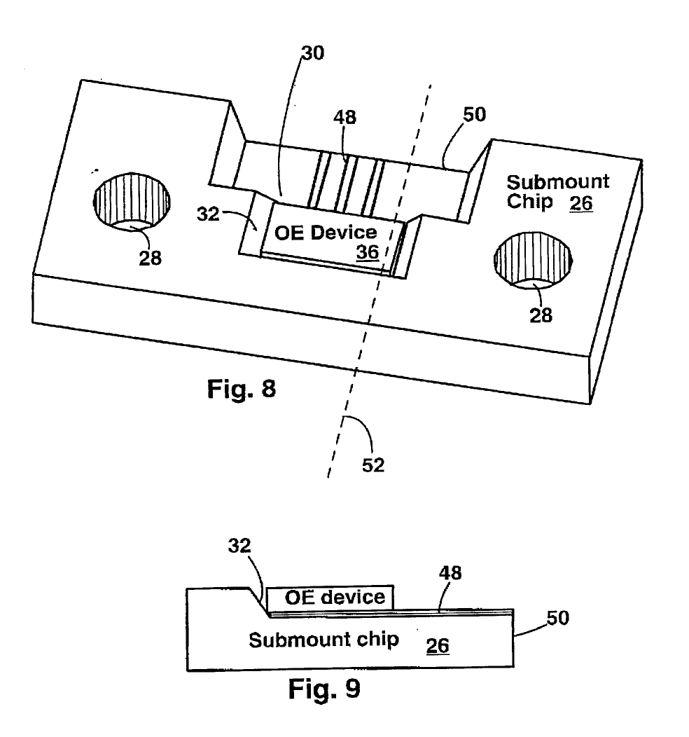

FIG. 8 shows an embodiment where the pit 30 extends to an edge 50 of the submount chip. In this embodiment, the transmission lines do not need to travel up a pit sidewall. It is beneficial for high speed devices to have the transmission lines 48 located in one plane.

FIG. 9 shows a cross sectional view of the embodiment of FIG. 8 cut along line 52. The OE device is electrically connected to transmission lines 48 and is disposed against sidewall 32. The OE device can be connected to the transmission lines by solder bumps, or by wire bonding. Wire bonding is generally not preferred for high speed signals.

In cases where solder bumps are used to bond the OE device to the submount, the height of the solder bumps must be considered if the sidewall 32 is not vertical. With non-vertical sidewalls, the height of the solder bumps will affect the lateral position of the OE device when the OE device is disposed against the sidewall.

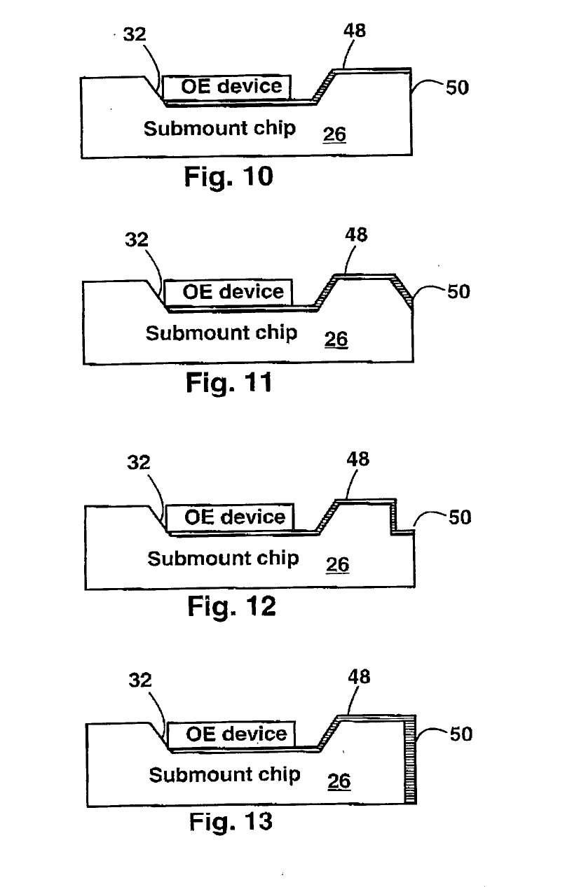

FIG. 10 shows a cross sectional view of the submount and OE device illustrating the transmission lines. The transmission lines extend to the edge 50 of the submount chip.

FIG. 11 shows an embodiment with an angled edge 50 to facilitate electrical connections to the transmission lines 48. The angled edge can be made by anisotropic etching of silicon. The angled edge allows for electrical connections to be made to the edge of the submount chip.

FIG. 12 shows another embodiment where the edge 50 has a square cut-out shape for the transmission line 48. The square cut-out can be made by RIE. The square cut-out shape also provides for electrical connection to the edge of the submount chip.

FIG. 13 shows yet another embodiment where the transmission lines 48 extend along the chip edge 50 to facilitate electrical connection.

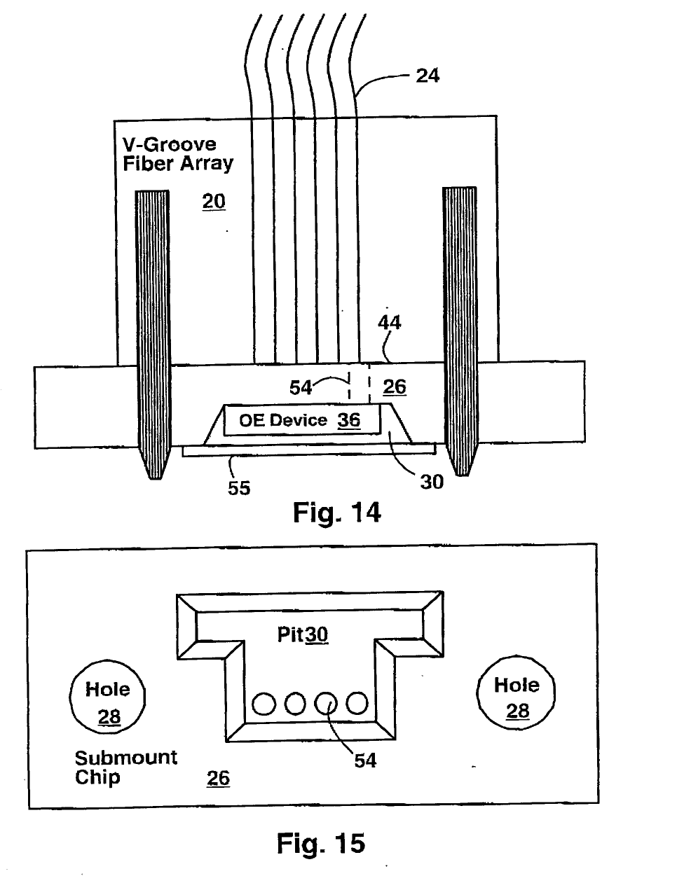

FIG. 14 illustrates an alternative embodiment of the present invention where the OE device and pit 30 are located on a backside of the submount chip. In this embodiment, the submount must either (1) have holes 54 (shown with dotted lines) in the pit for light to travel between the OE device and optical fibers, or (2) be transparent. If the submount is made of silicon, for example, then infrared signals can travel through the submount. The submount chip can also have a cover 55 for protecting the OE device.

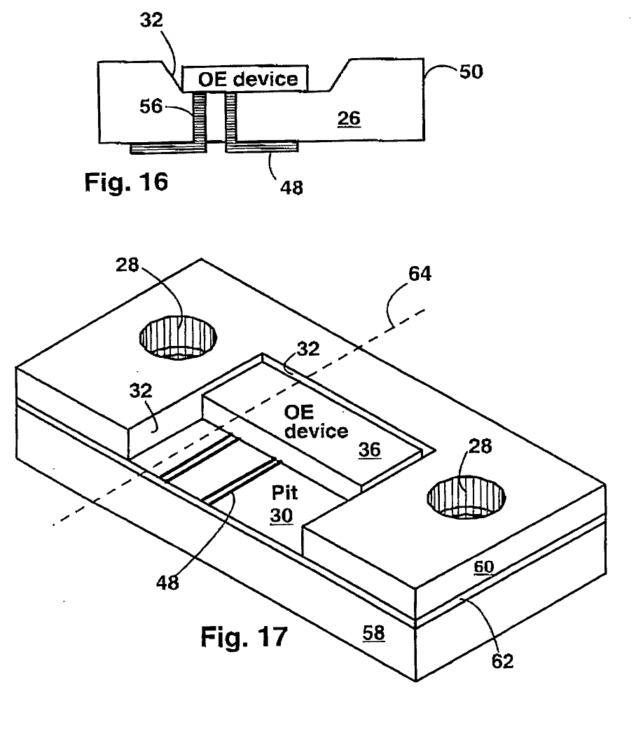

FIG. 15 shows a top view of a submount 26 having holes 54. Holes 56 are intended for use in embodiments where optical signals must travel through the submount chip.

FIG. 16 shows another embodiment of the present invention where electrical connection vias 56 extend through the submount chip 26. The vias can be made in many different ways as known in the art. For example, if the submount is made of silicon, the vias can be formed by wet anisotropic etching from the backside of the submount (the ‘backside’ is opposite the pit 30). The vias can also be made by reactive ion etching holes and then plating the holes with metal. If vias are used, the transmission lines 48 can be located on the backside of the submount.

FIG. 11 shows an embodiment of the present invention where the submount chip is made from a silicon-on-insulator (SOI) wafer.

The SOI submount chip has a handle layer 58, an insulator layer 62 and a device layer 60. The device layer 60 is etched away in areas to provide the micromachined pit 30. The OE device is disposed upon the insulator layer 62 (e.g., SiO2 or Si3N4). Also, the transmission lines 48 are disposed on top of the insulator layer 62. Preferably, the pit 30 is machined from the device layer using DRIE so that the sidewalls 32 are vertical, or within a few degrees of vertical. Also preferably, the device layer 60 is slightly thicker than the OE device 36 so that the OE device does not extend above the submount top surface.

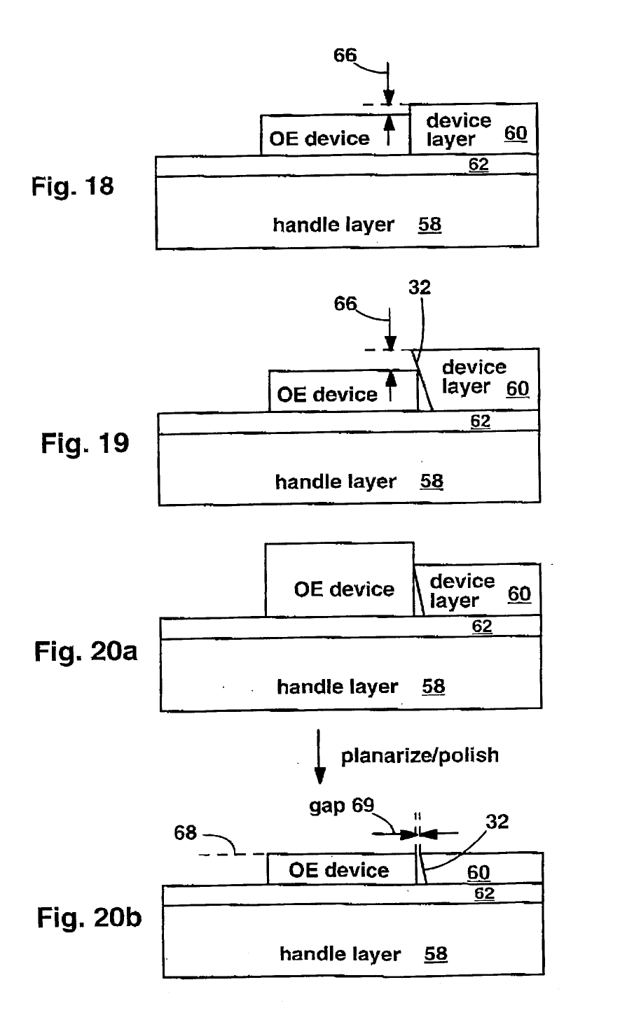

FIG. 18 shows a cross sectional view cut across line 64 in FIG. 17. The OE device thickness and device layer thickness are selected so that a step 66 is preferably less than 100, 50, 25, 10, or 5 microns. A small step 66 (e.g. less than 20 microns) is preferred for improved optical coupling between the optical fibers (or waveguides) and the OE device. Also, a small step 66 is preferred because it results in accurate alignment of the OE device. This is because sidewalls 32 are difficult to make precisely vertical using RIE processes.

FIG. 19, for example, shows a sidewall 32 that is slightly undercut. The undercut results in the OE device shifting to the right. A large step 66 produces a large displacement to the right. The OE device is most accurately aligned if the step 66 is small and the sidewall is close to or precisely vertical.

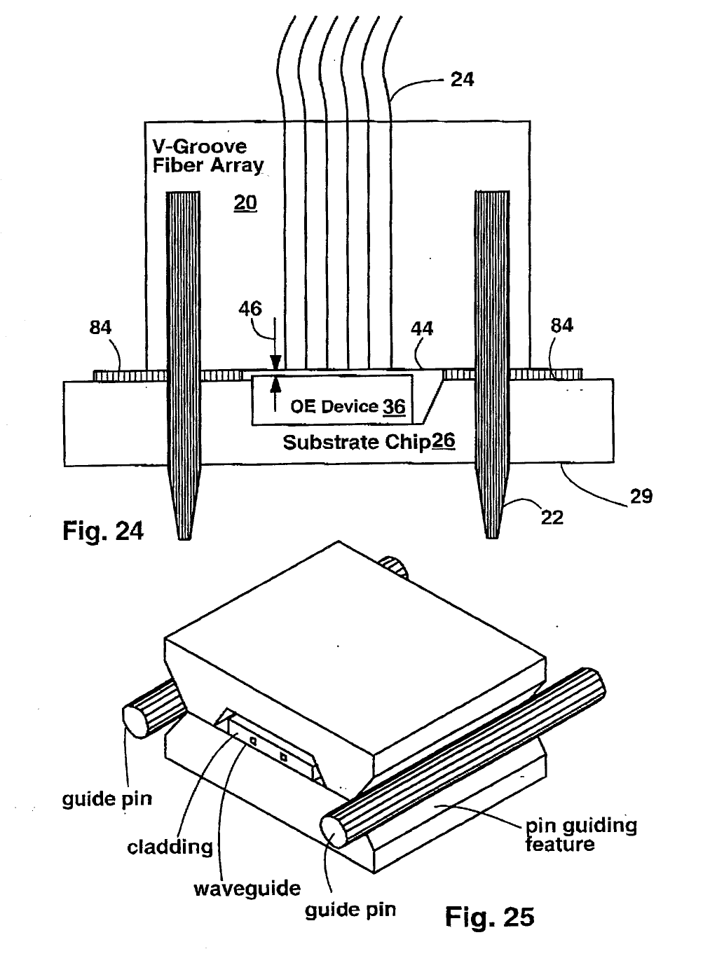

Optionally, in FIG. 20a, the OE device is taller than the device layer. Here, the OE device is accurately located even if the sidewall 32 is undercut (but not if the sidewall is V-shaped, or ‘overcut’). In this embodiment, a spacer layer may be disposed on top of the submount chip to prevent the waveguide array from contacting the OE device (shown in FIG. 24). Optionally in this embodiment, the OE device and device layer are simultaneously planarized and polished. This results in essentially zero gap 46 (shown in FIG. 3) between the array front face and the OE device when the connector is assembled.

FIG. 20b shows an embodiment where the device of FIG. 20 is planarized/polished to a level 68. The OE device is accurately located with respect to the guide pin holes (not shown) because the OE device was passively located with respect to the top of the sidewall 32 (in FIG. 20a). However, after planarization and polishing, the OE device is no longer in contact with the sidewall 32. When the submount of FIG. 20b is connected to the array 20 (in FIGS. 1 and 3), the gap distance 46 (shown in FIG. 3) will be essentially zero.

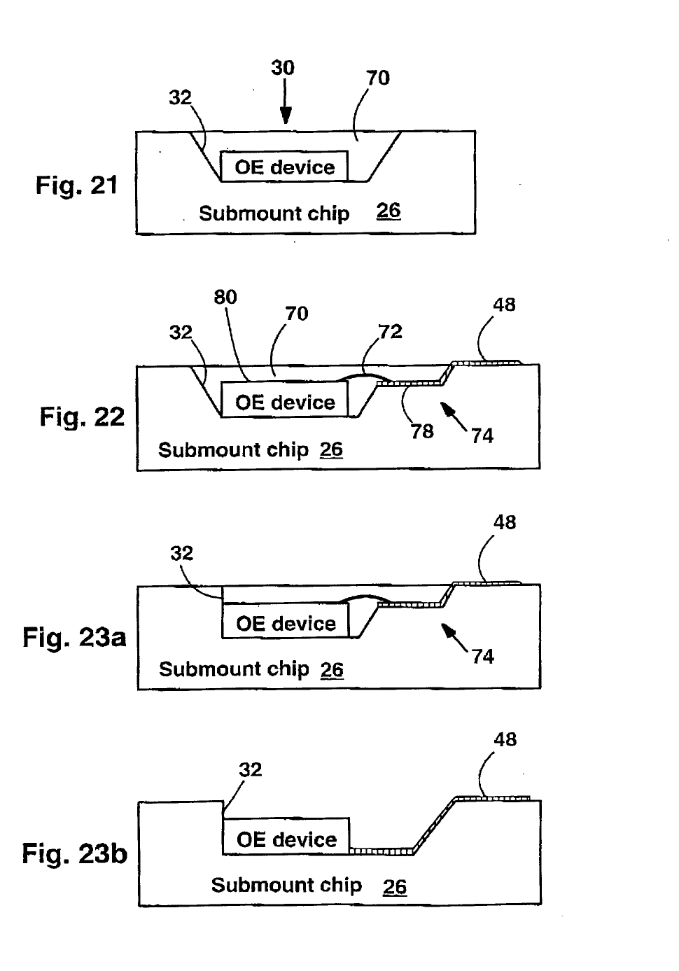

FIG. 21 shows yet another embodiment of the present invention where the pit 30 is filled with potting resin 70. The resin covers and protects the OE device. The resin may comprise optical-grade epoxy, for example.

FIG. 22 shows yet another embodiment where the submount chip 26 has a two-level sidewall 74. The two-level sidewall has a transmission line 48 and a wire bond wire 72. A step 78 in the two-level sidewall is level with the top surface 80 of the OE device. The two-level sidewall simplifies the task of wire-bonding between the OE device and the transmission line 48. FIG. 23a shows another embodiment where the submount has a vertical sidewall 32 (made by RIE, for example) combined with a two-level sidewall 74. The two-level sidewall can be made using known wet anisotropic etching techniques.

FIG. 23b shows yet another embodiment having a vertical sidewall 32 in combination with a sloping sidewall for transmission lines 48. The sloping sidewall can be made by wet anisotropic etching of silicon, and the vertical sidewall 32 can be made by RIE, for example.

FIG. 24 shows an embodiment where the OE device 36 is taller than the submount chip. The OE device may be taller than the submount chip in cases where the sidewall 32 is undercut (this is so because only the top edge of an undercut sidewall is accurately located). A spacer layer 84 is disposed on top of the submount chip. The spacer layer prevents the waveguide array from contacting and possibly damaging the OE device. The spacer layer 84 may be made of polymer materials, metal thin films or dielectric thin films. In this embodiment, the spacer layer thickness determines the gap spacing 46.

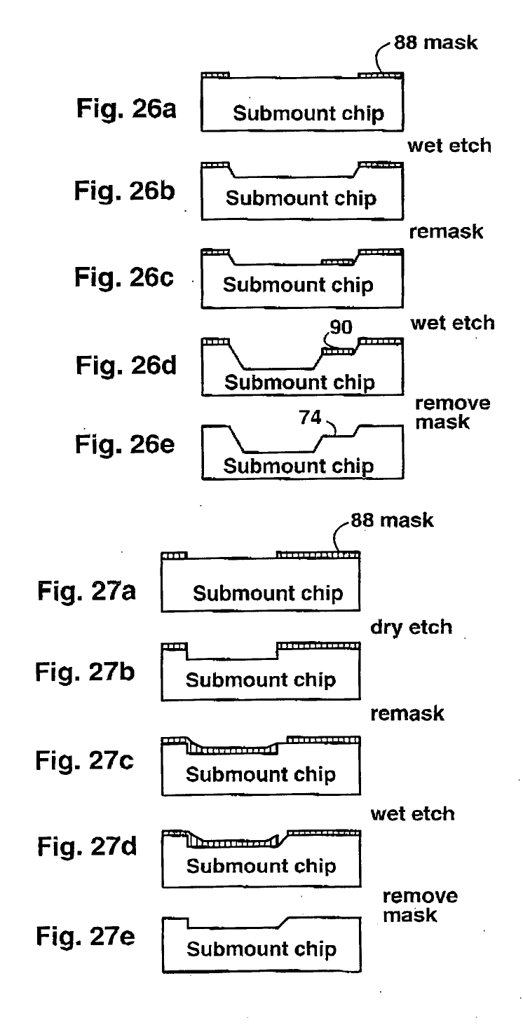

FIGS. 26a-e illustrate a method for making the submount chip with a two-level sidewall. Mask 88 is applied to the submount chip and a pit is etched to the level of the step. Then, a second mask 90 is applied and etching is repeated, resulting in a two-level sidewall 74.

FIGS. 27a-e illustrate a method for making a micromachined pit having vertical (dry etched) sidewalls (for passive location of the OE device) and sloped (wet etched) sidewalls (for transmission lines). Dry etching is performed according to a first mask, then wet etching is performed according to a second mask that protects the dry-etched sidewalls used for alignment. The result is a pit having both vertical and sloped sidewalls.

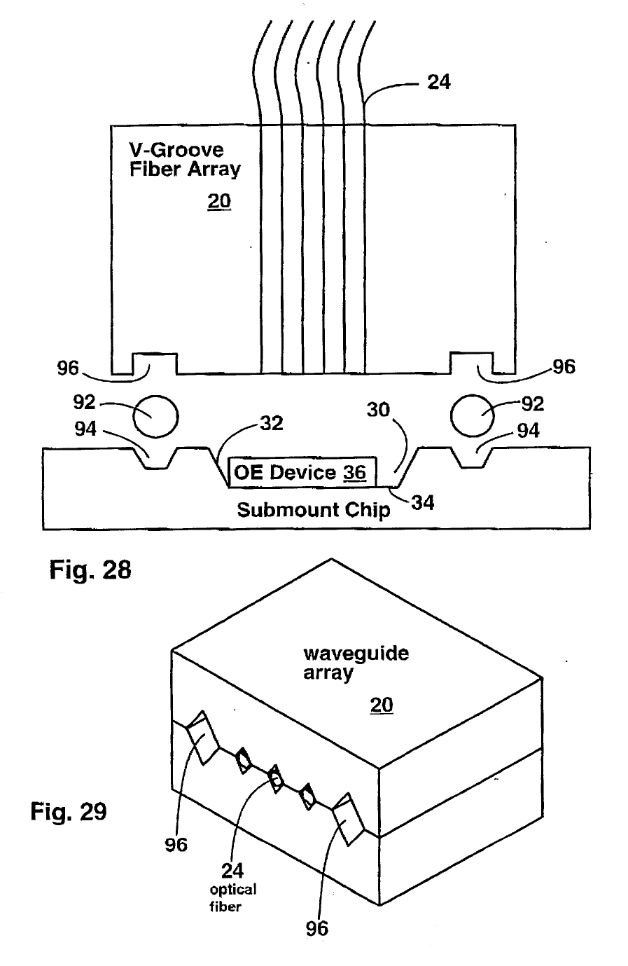

FIG. 28 illustrates yet another embodiment of the present invention where the guide pins 22 and holes 28 are replaced with spherical ball lenses 92 and etched sphere-guiding pits 94, respectively. Guide pins are not essential in the present invention. The waveguide array 20 has sphere-guiding features 96, which can be pits or holes. Preferably, the sphere-guiding pits of the submount are anisotropically etched pits in <100> silicon. The sphere-guiding pits in the submount can also be dry-etched or isotropically etched pits. Also preferably, the sphere-guiding features 96 of the waveguide are anisotropically etched pits or v-grooves. FIG. 29, shows the sphere-guiding features 96 of the waveguide array in a specific embodiment of the invention.

It is noted that the present invention can couple OE devices to many types of optical waveguides, including integrated optical waveguides and optical fibers. In order to couple the present submount to integrated optical waveguides, the waveguides must be aligned with pin guiding features. Suitable integrated optical waveguide structures are described in copending provisional patent application No. 60/197,130 by Dan Steinberg and David Sherrer filed on Apr. 14, 2000, and is hereby incorporated by reference. FIG. 25, for example illustrates an exemplary integrated optic waveguide structure having pin guiding features and guide pins.

Although the present invention has been shown as orienting the optoelectronic chip perpendicular to the optical waveguides and light signals, the optoelectronic chip can also be oriented at an angle with respect to the light signals and optical waveguides. In the present specification, the optoelectronic chip is approximately perpendicular if it is oriented within 10 degrees of perpendicular. It may be desirable to orient the optoelectronic chip off perpendicular to minimize back reflections, for example.

It will be clear to one skilled in the art that the above embodiment may be altered in many ways without departing from the scope of the invention. Accordingly, the scope of the invention should be determined by the following claims and their legal equivalents.

What is claimed is:

1. An apparatus for, connecting an optoelectronic device with an optical waveguide, comprising:
a) a submount chip having a micromachined pit with a sidewall, and having at least two pin-guiding features extending through the submount chip for connection to guide pins oriented perpendicular to the submount chip;
b) an optoelectronic device disposed in the micromachined pit, wherein the optoelectronic device is oriented to couple to light signals traveling approximately perpendicular to the submount chip;
c) a waveguide array having at least one optical waveguide and at least two pin-guiding features approximately parallel to the optical waveguide;
d) at least two guide pins for contact with the pin-guiding features of the submount and for contact with the pin-guiding features of the waveguide array, whereby the pin-guiding features provide alignment between the optical waveguides and the optoelectronic device.

2. The apparatus of claim 1 wherein the optoelectronic device is disposed against the sidewall.

3. The apparatus of claim 1 wherein the micromachined pit has a depth greater than a thickness of the optoelectronic device so that a gap 46 exists between the waveguide array and the optoelectronic device when connected.

4. The apparatus of claim 3 wherein the gap 46 is in the range of 0.1-10 microns.

5. The apparatus of claim 1 wherein the pin-guiding features of the submount comprise holes extending through the submount chip.

6. The apparatus of claim 1 wherein the pin-guiding features of the submount comprise notched edges 65.

7. The apparatus of claim 1 wherein the submount chip comprises single crystal silicon, and the micromachined pit is an anisotropically wet etched pit so that the sidewall is defined by <111> silicon crystal planes.

8. The apparatus of claim 7 wherein the submount chip is made from a <100> silicon water so that the sidewall is oriented at a 54 degree angle with respect to the submount chip.

9. The apparatus of claim 1 wherein the submount chip comprises a silicon-on-insulator chip having a device layer, and the micromachined pit is formed in the device layer and extends down to the insulator layer.

10. The apparatus of claim 1 wherein the micromachined pit is an anisotropically dry etched pit.

11. The apparatus of claim 10 wherein the sidewall is within 2 degrees of vertical.

12. The apparatus of claim 11 wherein the optoelectronic device is disposed against the sidewall.

13. The apparatus of claim 10 wherein the submount further comprises a second sidewall, wherein the second sidewall has a slope of at least 30 degrees from vertical.

14. The apparatus of claim 12 wherein the second sidewall is a wet etched sidewall defined by a <111> crystal plane of silicon.

15. The apparatus of claim 1 further comprising electrical transmission lines 48 electrically connected to the optoelectronic device and wherein the submount further comprises a second sloping sidewall, and wherein transmission lines extend over the second sloping sidewall of the micromachined pit.

16. The apparatus of claim 15 wherein the submount chip is made from a <100> silicon wafer and the second sloping sidewall is defined by a <111> crystal plane and is oriented at a 54 degree angle with respect to the submount chip.

17. The apparatus of claim 1 wherein the submount chip has electrical vias 56 extending from the micromachined pit through the submount chip.

18. The apparatus of claim 1 wherein the micromachined pit is filled with a potting resin, and the potting resin covers the optoelectronic device.

19. the apparatus of claim 1 wherein the micromachined pit has a two-level sidewall with a step 78, wherein the step is approximately level with a top surface of the optoelectronic device.

20. The apparatus of claim 19 further comprising a transmission line on the two-level sidewall, and a wire-bond extending from the optoelectronic device to the step.

21. The apparatus of claim 1 wherein the optoelectronic device and the submount chip have coplanar surfaces so that a gap 46 is essentially nonexistent.

22. The apparatus of claim 1 wherein the micromachined pit extends to an edge of the submount chip.

23. The apparatus of claim 1 wherein the optoelectronic device is separated from the sidewall by a gap 69, and wherein the sidewall is undercut, and wherein the optoelectronic device and submount chip have simultaneously lapped surfaces.

24. An optoelectronic submount apparatus for connection to an optical waveguide array with guide pins, comprising:
a) a submount chip having a micromachined pit with a sidewall, and having at least two pin-guiding features extending through the submount chip for connection to guide pins oriented perpendicular to the submount chip;
b) an optoelectronic device disposed in the micromachined pit, wherein the optoelectronic device is oriented to couple to light signals traveling approximately perpendicular to the submount chip.

25. The apparatus of claim 24 wherein the optoelectronic device is disposed against the sidewall.

26. The apparatus of claim 24 wherein the micromachined pit extends to an edge of the submount chip.

27. The apparatus of claim 24 wherein the pin-guiding features of the submount comprise holes extending through the submount chip.

28. The apparatus of claim 24 wherein the pin-guiding features of the surmount comprise notched edges 65.

29. The apparatus of claim 24 wherein the submount chip comprises single crystal silicon, and the micromachined pit is an anisotropically wet etched pit so that the sidewall is defined by <111> silicon crystal planes.

30. The apparatus of claim 29 wherein the submount chip is made from a <100> silicon wafer so that the sidewall is oriented at a 54 degree angle with respect to the submount chip.

31. The apparatus of claim 24 wherein the submount chip comprises a silicon-on-insulator chip having a device layer, and the micromachined pit is formed in the device layer and extends down to the insulator layer.

32. The apparatus of claim 24 wherein the micromachined pit is an anisotropically dry etched pit.

33. The apparatus of claim 32 wherein the sidewall is within 2 degrees of vertical.

34. The apparatus of claim 33 wherein the optoelectronic device is disposed against the sidewall.

35. The apparatus of claim 32 wherein the submount further comprises a second sloping sidewall, wherein the second sloping sidewall has a slope of at least 30 degrees from vertical.

36. The apparatus of claim 35 wherein the second sloping sidewall is a wet etched sidewall defined by a <111> crystal plane of silicon.

37. The apparatus of claim 24 further comprising electrical transmission lines 48 electrically connected to the optoelectronic device and wherein the submount further comprises a second sloping sidewall, and wherein transmission lines extend over the second sloping sidewall of the micromachined pit.

38. The apparatus of claim 37 wherein the submount chip is made from a <100> silicon wafer and the second sloping sidewall is defined by a <111> crystal plane and is oriented at a 54 degree angle with respect to the submount chip.

39. The apparatus of claim 24 wherein the submount chip has electrical vias 56 extending from the micromachined pit through the submount chip.

40. The apparatus of claim 24 wherein the micromachined pit is filled with a potting resin, and the potting resin covers the optoelectronic device.

41. the apparatus of claim 24 wherein the micromachined pit has a two-level sidewall with a step 78, wherein the step is approximately level with a top surface of the optoelectronic device.

42. The apparatus of claim 41 further comprising a transmission line on the two-level sidewall, and a wire-bond extending from the optoelectronic device to the step.

43. The apparatus of claim 24 wherein the optoelectronic device and the submount chip essentially coplanar surfaces.

44. The apparatus of claim 24 wherein the micromachined pit has a depth greater than a thickness of the optoelectronic device.

45. The apparatus of claim 24 wherein the optoelectronic device is separated from the sidewall by a gap 69, and wherein the sidewall is undercut, and wherein the optoelectronic device and submount chip have simultaneously lapped surfaces.

46. An apparatus for connecting an optoelectronic device with an optical waveguide, comprising:
a) a submount chip having a micromachined pit with a sidewall, and having at least two sphere-guiding pits etched into the submount chip for connection to spheres;
b) an optoelectronic device disposed in the micromachined pit, wherein the optoelectronic device is oriented to couple to light signals traveling approximately perpendicular to the submount chip;
c) a waveguide array having at least one optical waveguide and at least two sphere-guiding features;
d) at least two guide spheres for contact with the sphere-guiding pits of the submount and for contact with the sphere-guiding features of the waveguide array, whereby the sphere-guiding features provide alignment between the optical waveguides and the optoelectronic device.

47. The apparatus of claim 46 wherein the optoelectronic device is disposed against the sidewall.

48. The apparatus of claim 46 wherein the micromachined pit has a depth greater than a thickness of the optoelectronic device so that a gap 46 exists between the waveguide array and the optoelectronic device when connected.

49. The apparatus of claim 48 wherein the gap 46 is in the range of 0.1-10 microns.

50. The apparatus of claim 46 wherein the sphere-guiding pits of the submount comprise anisotropically etched pits in <100> silicon.

51. The apparatus of claim 46 wherein the submount chip comprises single crystal silicon, and the micromachined pit is an anisotropically wet etched pit so that the sidewall is defined by <111> silicon crystal planes.

52. The apparatus of claim 51 wherein the submount chip is made from a <100> silicon wafer so that the sidewall is oriented at a 54 degree angle with respect to the submount chip.

53. The apparatus of claim 46 wherein the submount chip comprises a silicon-on-insulator chip having a device layer, and the micromachined pit is formed in the device layer and extends down to the insulator layer.

54. The apparatus of claim 46 wherein the micromachined pit is an anisotropically dry etched pit.

55. The apparatus of claim 54 wherein the sidewall is within 2 degrees of vertical.

56. The apparatus of claim 55 wherein the optoelectronic device is disposed against the sidewall.

57. The apparatus of claim 54 wherein the submount further comprises a second sidewall, wherein the second sidewall has a slope of at least 30 degrees from vertical.

58. The apparatus of claim 57 wherein the second sidewall is a wet etched sidewall defined by a <111> crystal plane of silicon.

59. The apparatus of claim 46 further comprising electrical transmission lines 48 electrically connected to the optoelectronic device and wherein the submount further comprises a second sloping sidewall, and wherein transmission lines extend over the second sloping sidewall of the micromachined pit.

60. The apparatus of claim 59 wherein the submount chip is made from a <100> silicon wafer and the second sloping sidewall is defined by a <111> crystal plane and is oriented at a 54 degree angle with respect to the submount chip.

61. The apparatus of claim 46 wherein the submount chip has electrical vias 56 extending from the micromachined pit through the submount chip.

62. The apparatus of claim 46 wherein the micromachined pit is filled with a potting resin, and the potting resin covers the optoelectronic device.

63. The apparatus of claim 46 wherein the micromachined pit has a two-level sidewall with a step 78, wherein the step is approximately level with a top surface of the optoelectronic device.

64. The apparatus of claim 63 further comprising a transmission line on the two-level sidewall, and a wire-bond extending from the optoelectronic device to the step.

65. The apparatus of claim 46 wherein the optoelectronic device and the submount chip have coplanar surfaces so that a gap 46 is essentially nonexistent.

66. The apparatus of claim 46 wherein the micromachined pit extends to an edge of the submount chip.

67. The apparatus of claim 46 wherein the optoelectronic device is separated from the sidewall by a gap 69, and wherein the sidewall is undercut, and wherein the optoelectronic device and submount chip have simultaneously lapped surfaces.

68. An optoelectronic submount apparatus for connection to an optical waveguide array with guide pins, comprising:
a) a submount chip having a micromachined pit with a sidewall, and having at least two sphere-guiding pits etched into the submount chip for connection to spheres;
b) an optoelectronic device disposed in the micromachined pit, wherein the optoelectronic device is oriented to couple to light signals traveling approximately perpendicular to the submount chip.

69. The apparatus of claim 68 wherein the optoelectronic device is disposed against the sidewall.

70. The apparatus of claim 68 wherein the micromachined pit extends to an edge of the submount chip.

71. The apparatus of claim 68 wherein the sphere-guiding pits of the submount comprise anisotropically etched pits in <100> silicon.

72. The apparatus of claim 68 wherein the submount chip comprises single crystal silicon, and the micromachined pit is an anisotropically wet etched pit so that the sidewall is defined by <111> silicon crystal planes.

73. The apparatus of claim 72 wherein the submount chip is made from a <100> silicon wafer so that the sidewall is oriented at a 54 degree angle with respect to the submount chip.

74. The apparatus of claim 68 wherein the submount chip comprises a silicon-on-insulator chip having a device layer, and the micromachined pit is formed in the device layer and extends down to the insulator layer.

75. The apparatus of claim 68 wherein the micromachined pit is an anisotropically dry etched pit.

76. The apparatus of claim 75 wherein the sidewall is within 2 degrees of vertical.

77. The apparatus of claim 76 wherein the optoelectronic device is disposed against the sidewall.

78. The apparatus of claim 75 wherein the submount further comprises a second sloping sidewall, wherein the second sloping sidewall has a slope of at least 30 degrees from vertical.

79. The apparatus of claim 78 wherein the second sloping sidewall is a wet etched sidewall defined by a <111> crystal plane of silicon.

80. The apparatus of claim 68 further comprising electrical transmission lines 48 electrically connected to the optoelectronic device and wherein the submount further comprises a second sloping sidewall, and wherein transmission lines extend over the second sloping sidewall of the micromachined pit.

81. The apparatus of claim 80 wherein the submount chip is made from a <100> silicon wafer and the second sloping sidewall is defined by a <111> crystal plane and is oriented at a 54 degree angle with respect to the submount chip.

82. The apparatus of claim 68 wherein the submount chip has electrical vias 56 extending from the micromachined pit through the submount chip.

83. The apparatus of claim 68 wherein the micromachined pit is filled with a potting resin, and the potting resin covers the optoelectronic device.

84. The apparatus of claim 68 wherein the micromachined pit has a two-level sidewall wish a step 78, wherein the step is approximately level with a top surface of the optoelectronic device.

85. The apparatus of claim 84 further comprising a transmission line on the two-level sidewall, and a wire-bond extending from the optoelectronic device to the step.

86. The apparatus of claim 68 wherein the optoelectronic device and the submount chip essentially coplanar surfaces.

87. The apparatus of claim 68 wherein the micromachined pit has a depth greater than a thickness of the optoelectronic device.

88. The apparatus of claim 68 wherein the optoelectronic device is separated from the sidewall by a gap 69, and wherein the sidewall is undercut, and wherein the optoelectronic device and submount chip have simultaneously lapped surfaces.
